(19) United States
(12) Patent Application Publication
(10) Pub. No.: US 2005/0085280 A1
(43) Pub. Date: Apr. 21, 2005

(54) Imaging apparatus

(75) Inventor: Yuichi Takahashi, Kanagawa (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/965,288

(22) Filed: Oct. 14, 2004

(30) Foreign Application Priority Data
Oct. 16, 2003 (JP) P. 2003-356927

(51) Int. Cl. H04M 1/00

(52) U.S. Cl. 455/575.1

(57) ABSTRACT

An imaging apparatus has a housing having a display section and another housing having a key input section, which are coupled through a coupling section, and state determination section that determines whether the two housings is in an opened state or in a closed state. The arrangement of images of reference information to be displayed on a display screen of the display section along with a picked-up image is changed in accordance with the determination result made by the state determination section.

### BACKGROUND OF THE INVENTION

1. Field of the Invention

The invention relates to an imaging apparatus for picking up images or video.

2. Description of the Related Art

In order to display various information (e.g., a shutter speed, the amount of exposure compensation, the number of exposures, or the like) regarding an imaging operation of a camera, a comparatively-high-performance camera has been provided with a compact display device, such as an LCD (Liquid Crystal Display).

For instance, JP-2002-162674 discloses a camera equipped with a liquid crystal display section for displaying such information.

In association with enhancement of processing capability of a processor or development of power saving technique, performance of a portable electronic device, such as a portable cellular phone or a PDA, have become more enhanced, and a portable cellular phone having a function of picking up images or video has now become popular. A display device for displaying various information along with a picked-up image, such as an LCD, is utilized for the portable cellular phone having such an imaging function.

JP-2002-162674 is referred to as a related art.

In many recent portable cellular phones, a display section and a key input section are arranged separately in different housings. The portable cellular phone of this type enables to be in two states as common operation styles; namely, a state in which two housings are folded, and a key input section is hidden inside the folded housings (a closed state); and a state in which the key input section and the display section are exposed (an opened state).

The structures of these two housing types generally include a type where the display section is hidden inside in the closed state and a type where the display section remains exposed outside.

The former type includes, e.g., a type where the display section and the input section are folded inside while the surfaces thereof face each other. The latter type includes, e.g., a type having a mechanism for rotating the display section and the key input section relative to each other while the surfaces thereof are aligned substantially in parallel to each other, in which the surface of the key input section is hidden below the housing of the display section in the closed state.

In the case of the latter type, the display section can be used in either an opened state or a closed state. The camera can usually perform imaging operation in either of the operation styles.

When a user takes a photograph in either operation styles, the user changes the manner of holding the portable cellular phone to suit the operation style so that the portable cellular phone sometimes becomes easy to operate as a camera.

The user can use the key input section in the opened state. Therefore, when consideration is given to use of the portable cellular phone by one hand, it is preferable for the user to carry out photographing while holding the housing of the key input section. On the other hand, the user cannot use the key input section in the closed state. For this reason, in many cases, it is necessary for the user to use another shutter button which is different from that used in the opened state. Consequently, it becomes easy for the user to use the portable cellular phone as a camera depending on the position of the shutter button for the closed state, by changing the manner of holding the housing.

However, even when the operation style has been changed, the arrangement of reference images (characters or symbols) of various information to be displayed on the display section along with a picked-up image remains unchanged. For this reason, when the orientation of the display screen in relation to the user has become changed in association with a change in the operation style, the visibility of the reference information is deteriorated, thereby becoming difficult to operate the portable cellular phone.

### SUMMARY OF THE INVENTION

The object of the invention is to provide an imaging apparatus having two housings coupled through a movable coupling section and a display section provided in one of the two housings, wherein a picked-up image and images regarding reference information can be displayed on the display section in a state appropriate for a state of the two housings.

The invention provides an imaging apparatus having: a first housing; a second housing which has a display section for displaying a picked-up image and is coupled to the first housing through a coupling section; a state determination section that determines an opened/closed state of the second housing with respect to the first housing; and a control section that changes an arrangement of images regarding reference information to be displayed on a display screen of the display section along with the picked-up image, in accordance with a determination result made by the state determination section.

The imaging apparatus further has: a storage section that stores arrangement information of the image regarding the reference information in association with the determination result of the state determination section, wherein the control section acquires the arrangement information corresponding to the determination result of the state determination section from the storage section, and changes the arrangement of the images regarding the reference information in accordance with the acquired arrangement information.

The imaging apparatus further has: a plurality of information input sections that are arranged on one or both of the first housing and the second housing, and is used to input a control information for controlling processes regarding an imaging function of the imaging apparatus, wherein the control section sets association between the control information and the information input section to be used for inputting the control information, in accordance with the determination result of the state determination section, and changes position and orientation on the display screen of images representing at least part of the information input sections to which the association is set, in accordance with the determination result of the state determination section.

The reference information includes at least one of a zoom rate of picking up an image and an elapsed time of picking up video, and the control section changes position and orientation on the display screen of the images regarding the reference information in accordance with the determination result of the state determination section.

The images regarding the reference information are formed in an essentially rectangular shape, and the control section changes a longitudinal length of the images in accordance with the determination result of the state determination section.

The reference information includes at least one of a zoom rate of the picking up an image and an elapsed time of picking up video, and the control section fixes position and orientation on the display screen of part of the images regarding the reference information regardless of the determination result of the state determination section, and changes the arrangement of other images regarding the reference information than the part of the images in accordance with the determination result of the state determination section.

The control section changes a size or an aspect ratio of the picked-up image to be displayed on the display screen in accordance with the determination result of the state determination section.

The invention also provides an imaging apparatus having two housings and a coupling section that rotatably couples the two housings, including: an imaging section; a display section that is disposed on one of the two housings and displays an image picked up by the imaging section; a state determination section that determines whether the two housings are in a first state where one housing having the display section covers a predetermined area of another housing, or in a second state where the predetermined area of the another housing is exposed; and a control section that changes an arrangement of images regarding reference information to be displayed on a display screen of the display section along with the picked-up image, in accordance with a result of a determination result made by the state determination section.

According to the invention, the imaging apparatus having two housings coupled through the coupling section and the display section provided in one of the two housings, a picked-up image and images regarding reference information can be displayed on the display section in a state appropriate for a state of the two housings.

### BRIEF DESCRIPTION OF THE DRAWINGS

FIGS. 1A to 1C are views illustrating an example appearance of a portable cellular phone in an opened state;

FIGS. 2A to 2C are views illustrating an example appearance of the portable cellular phone in a closed state;

FIG. 3 is a block diagram showing an example configuration of the portable cellular phone according to an embodiment of the invention;

FIG. 4 is a flowchart illustrating an example flow of processing of a camera mode;

FIGS. 5A and 5B are views illustrating an example image displayed during photographing operation of a camera when an image showing an association between control information and operation keys is included;

FIGS. 6A and 6B are views illustrating an example display image during the imaging operation of the camera when an image showing a zoom rate of a picked-up image is included;

FIG. 7 is a view illustrating an example in which the longitudinal length of the image showing a zoom rate is extended; and

FIG. 8 is a view illustrating an example in which the arrangement of the image showing the zoom rate remains identical during portrait and landscape photographing operations.

### DETAILED DESCRIPTION OF THE PREFERRED EMBODIMENTS

An embodiment in which the invention is applied to a portable cellular phone having an imaging function (imaging apparatus) will be described hereinbelow by reference to the drawings.

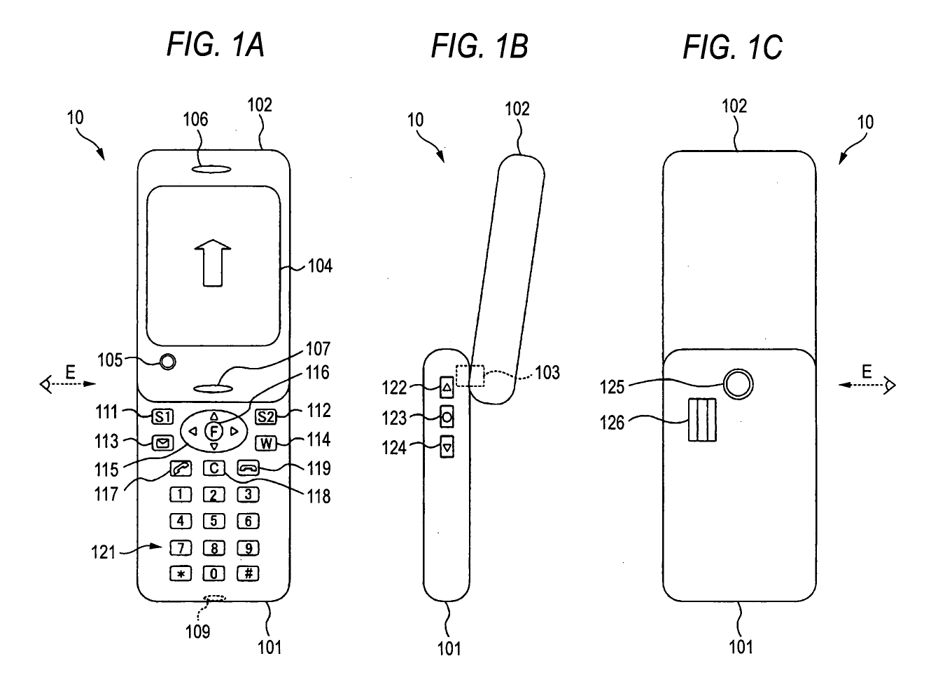

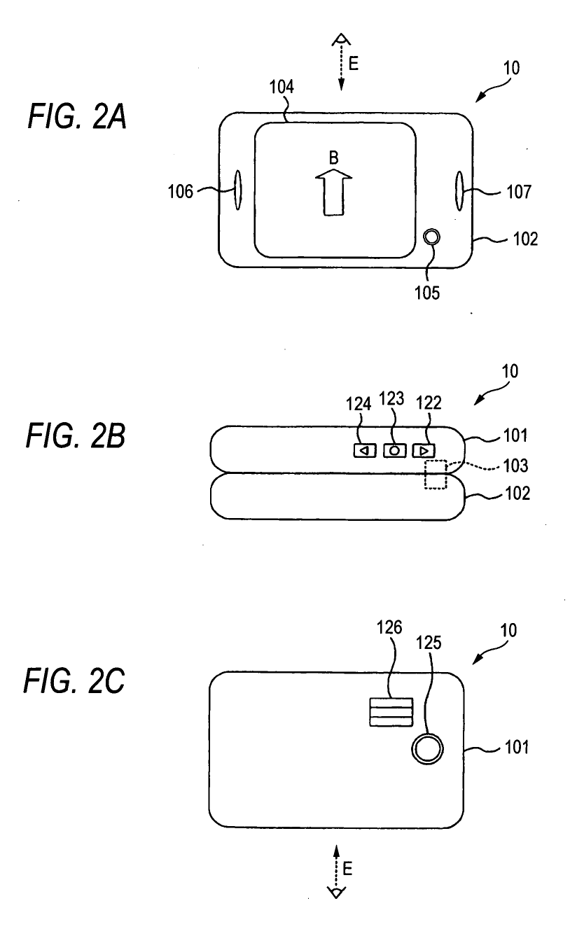

FIGS. 1A to 1C and FIGS. 2A to 2C are views illustrating example appearances of a portable cellar phone 10 according to the embodiment of the invention in which the portable cellular phone 10 is in an opened state and in a closed state.

FIGS. 1A, 1B, and 1C show the external front, external side, and external back of the opened portable cellular phone 10, respectively.

FIGS. 2A, 2B, and 2C show the external front, external side, and external back of the closed portable cellular phone 10, respectively.

As illustrated, the portable cellular phone 10 has two housings (a first housing 101 and a second housing 102), and these housings are coupled through a coupling section 103.

Each of the first housing 101 and the second housing 102 is in an essentially rectangular shape whose corners are all rounded, and the two housings are of similar size. These two housings are coupled through the coupling section 103, at a position on respective single rectangular surfaces of the housings, the position being close to centers of respective single shorter sides of the rectangular surfaces. The coupling section 103 allows the two housings to rotate relative to each other around an axis of rotation extending so as to penetrate through the rectangular surfaces of the housings.

As shown in FIGS. 1A and 1C, long sides of the two housings are in parallel each other in the opened state when viewed from the front or back. Short sides of the respective housings, which are spaced apart from each other with respect to the coupling section, are opposed each other in parallel with the axis of rotation interposed therebetween. Thus, the short sides are spaced most distant from each other. As shown in FIG. 1B, the second housing 102 is inclined with respect to the first housing 101 when viewed from the side.

As shown in FIGS. 2A and 2C, the long sides of the two housings are in parallel each other even in the closed state. However, the short sides of the housings spaced apart from each other with respect to the coupling section are opposed each other in parallel without the axis of rotation being interposed therebetween, and the short sides are closest each other when in this state. As shown in FIG. 2B, the rectangular surfaces of the first and second housings 101, 102 are in substantially parallel each other when viewed from the side, so that the two housings are respectively superimposed.

As shown in FIG. 1A, operation keys 111 to 119 and 121 are provided on the surface of the first housing 101 in opposite to the second housing 102 (hereinafter expressed as the “surface of the first housing 101”). All of the operation keys are used in the opened state and included in a key input section 154.

The operation keys 111 and 112 are assigned various functions in accordance with a processing mode.

Provided that the upper side of the first housing 101 is defined as a side close to the coupling section (this definition applies to explanations provided hereinbelow), the operation key 111 is disposed at the upper left corner on the surface of the first housing 101, and the operation key 112 is disposed at the upper right corner on the same surface.

The operation key 113 is a key assigned a function for invoking processing modes pertaining to preparation, transmission, and receipt of an E-mail, or the like, and is disposed at a position below the operation key 111 on the surface of the first housing 101.

The operation key 114 is a key assigned a function for invoking processing modes pertaining to browsing of a Web page of the Internet, or the like, and is disposed at a position below the operation key 112 on the surface of the first housing 101.

The operation key 115 is utilized for selecting an object of processing in each type of processing modes and has an oval shape including four direction keys; i.e., an up key, a down key, a left key, and a right key. For instance, the operation key 115 is used for moving the object of selection vertically or horizontally in a processing mode (hereinafter expressed as a “menu selection mode”) for prompting the user to select a processing item by displaying a list of processing menus. The operation key 115 is disposed at a position between the operation keys 111 and 113, and the operation keys 112 and 114 on the surface of the first housing 101.

The operation key 116 is a key utilized for determining a processing item in each type of processing modes. For instance, the operation key 116 is used for instructing determination of a selection result in the menu selection mode. In the processing mode for effecting photographing action with a camera (hereinafter expressed as a “camera mode”), the operation key 116 is used for instructing execution of photographing operation. The operation key 116 is disposed in the vicinity of the oval operation key 115.

The operation key 117 is utilized when receiving an incoming call in the phone mode or when making a call. The operation key 117 is disposed at a position on the surface of the first housing 101, the position being located to the lower right of the operation key 113 and to the lower left of the operation key 115.

The operation key 119 is utilized when processing in each type of processing modes is terminated. For instance, the operation key 119 is used when communication in a phone mode is completed. The operation key 119 is provided at a position on the surface of the first housing 101, the position being located to the lower left of the operation key 114 and to the lower right of the operation key 115.

The operation key 118 is utilized when characters or data are deleted in each type of processing modes. The operation key 118 is disposed between the operation keys 117 and 119 on the surface of the first housing 101.

The operation key 121 corresponds to a group of keys formed from twelve keys which are arranged below the operation keys 117 to 119 in a matrix with three columns x four rows; and which are to be used for inputting symbols. The twelve keys include keys to be used for inputting numerals “0” to “9,” letters “a” to “z” and “A” to “Z,” and symbols “*,” “#,” and “/.”

Operation keys 122 to 124 are arranged at positions on the left side surface of the first housing 101 (the side surface of the first housing 101 when viewed in the direction of arrow E), the positions being close to the coupling section, when the surface of the portable cellular phone is viewed with the coupling section being oriented upward.

The operation keys 122 to 124 are primarily used in the closed state and are assigned various functions in accordance with processing modes. The operation keys 122 to 124 are included in the key input section 154.

These three operation keys 122, 123, and 124 are arranged in this sequence from top to bottom at upper positions on the left side surface of the first housing 101.

A microphone hole 109 is provided at substantially the center of a lower side surface of the first housing 101 when the surface having the operation key 110 is viewed with the coupling section being oriented upward.

As shown in FIGS. 1A and 2A, a rectangular display screen 104 is provided on the surface of the second housing 102 which is not in opposite to the first housing 101. The display screen 104 is formed from a display device; for example, an LCD (Liquid Crystal Display) panel or an organic EL (ElectroLuminescent) panel, and is included in a display section 155 to be described later.

Holes 106, 107 for a speaker are provided at positions in the same plane where the display screen 104 is located, the positions being adjacent to respective short sides located at both ends with the display screen 104 sandwiched therebetween. The hole 107 is disposed in the vicinity of the short side near the coupling section, and the hole 106 is disposed in the vicinity of the opposite short side.

A camera lens 105 is disposed at a lower left corner on the surface when the portable cellular phone 10 is viewed with the coupling section located downward. The camera lens 105 includes an imaging section 157 to be described later.

As shown in FIGS. 1C and 2C, the camera lens 125 and a flash lamp 126 are arranged on the back of the first housing 101 which is not in opposite to the second housing 102. The camera lens 125 is arranged at a position on the back closer to the short side near the coupling section 103. The flash lamp 126 is arranged at a lower left position with respect to the camera lens 125 when the portable cellular phone 10 is viewed with the coupling section oriented upward. The camera lens 125 and the flash lamp 126 are included in the imaging section 157.

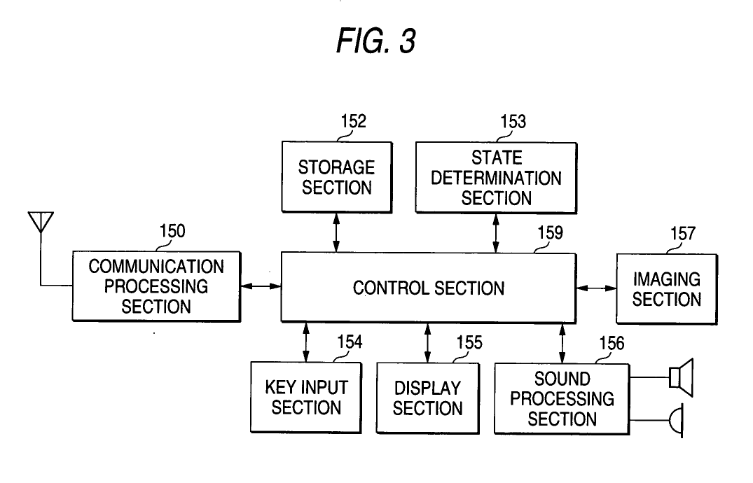

FIG. 3 is a block diagram showing an exemplary configuration of the portable cellular phone 10 of the embodiment.

The portable cellular phone 10 shown in FIG. 3 has a communication processing section 150, a storage section 152, a state determination section 153, the key input section 154, the display section 155, a sound input/output section 156, the imaging section 157, and a control section 159.

The communication processing section 150 performs processing for radio communication with a base station. For instance, transmission data to be output from the control section 159 are subjected to predetermined modulation processing, whereby the data are converted into a radio signal. Then, the resultant radio signal is transmitted from an antenna. The radio signal received by the antenna is subjected to predetermined demodulation processing, thereby regenerating received data. The resultant data are output to the control section 159.

The storage section 152 stores a program to be executed by the control section 159, constant data to be used in processing by the control section 159, variable data required to be temporarily stored, and picked-up image data.

The storage section 152 stores, e.g., a data table which associates arrangement information about an image of reference information to be displayed on a display screen along with a picked-up image, with a result of determination made by the state determination section 153.

The state determination section 153 determines whether the state of the second housing 102 with respect to the first housing 101 is the opened state or the closed state.

When any of the operation keys 116 or 123 is subjected to input operation, such as pressing, the key input section 154 generates a corresponding signal and outputs the signal to the control section 159.

The display section 155 displays on the display screen 104 an image corresponding to the image data generated by the control section 159.

The sound processing section 156 converts an input sound into an electrical sound signal by means of a microphone and subjects the sound signal to signal processing, such as amplification, analog-to-digital conversion, and encoding, and outputs to the control section 159 sound data resulting from processing of the signal. The sound data input from the control section 159 are subjected to signal processing, such as decoding, digital-to-analog conversion, and amplification, to thus generate the sound signal, and the sound signal is converted into sound by means of a speaker.

The imaging section 157 picks up an image entered through the camera lens 105 or 125 to generate image data of the image or video and outputs the thus-generated image or video images to the control section 159. In accordance with control operation of the control section 159, the imaging section 157 illuminates the flash lamp 126 at the time of imaging operation.

The control section 159 has a computer for carrying out processing in accordance with a program stored in the storage section 152 and performs various processing operations pertaining to overall operation of the portable cellular phone 10.

As processing relevant to the functions of the phone, there are performed processing operations; e.g., processing for controlling a call origination sequence and an incoming call sequence of the communication processing section 150 in accordance with the key input operation of the key input section 154; processing for causing the communication processing section 150 to receive or transmit the sound data input/output by the sound processing section 156; and processing for subjecting the image data generated by means of imaging operation to image processing, such as compression or encoding operation, and storing the thus-processed image data into the storage section 152.

The control section 159 sets an association between at least a portion of information (hereinafter expressed as control information) for controlling the flow of these processing operations and an operation key to be used for inputting the information, in accordance with a result of determination made by the state determination section 153. Specifically, the control section 159 associates at least a portion of the control information with a different operation key in accordance with the opened/closed state.

For example, in the camera mode, the control section 159 inputs, as control information by way of the key input section 154, imaging execution information to be used for instructing execution of imaging operation, zoom rate setting information to be used for setting a zoom rate, and mode transition information to be used for shifting a mode to a menu selection mode in order to set various information pertaining to photographing action of the camera.

The control section 159 sets an association between the control information and the operation keys, as provided in the following table. Specifically, in the opened state, the imaging execution information is associated with the operation key 116; the zoom rate setting information is associated with the operation key 111; and the mode transition information is associated with the operation key 112. In the closed state, the imaging execution information is associated with the operation key 123; the zoom rate setting information is associated with the operation key 124; and the mode transition information is associated with the operation key 122.

| Control Information | Opened State | Closed State |
|---|---|---|
| Execution of Imaging | 116 | 123 |
| Setting of Zoom Rate | 111 | 124 |
| Mode Transition | 112 | 122 |

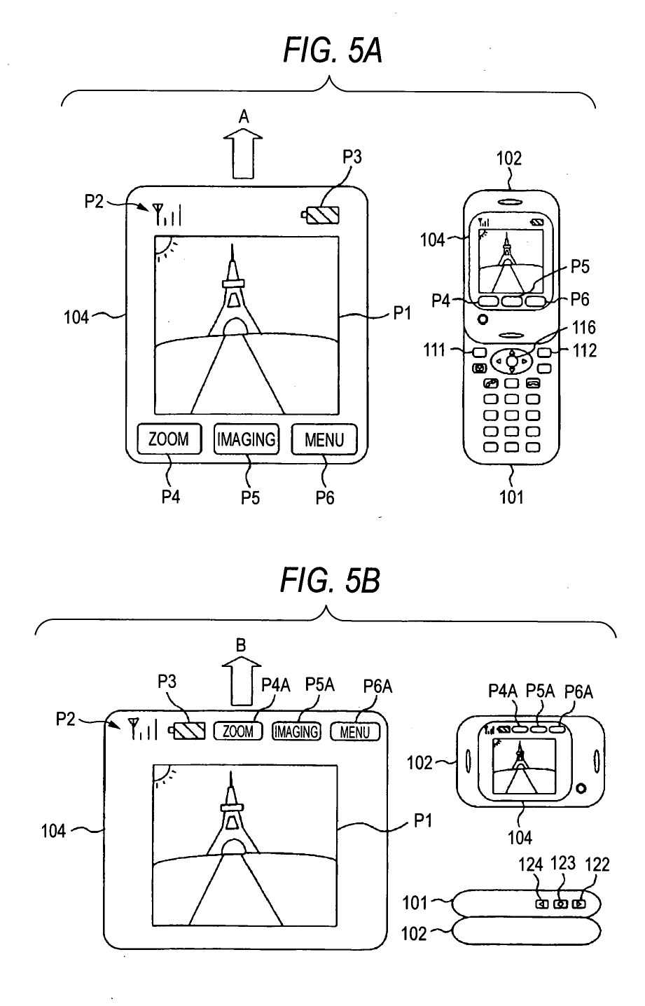

Moreover, the control section 159 displays, on the display section 155, images of various reference information along with the image picked up by the imaging section 157 in the camera mode. As shown in FIGS. 5A and 5B to be described later, the images of reference information include, e.g., images (P4 to P6, and P4A to P6A) representing an association between control information and the operation keys, an image (P2) showing receiving intensity of a signal transmitted by the base station, and images (P3) showing the remaining power of a battery.

In this case, the control section 159 changes the arrangement (e.g., the position or orientation) of an image of reference information on the display screen 104 in accordance with a result of determination made by the state determination section 153. Specifically, the arrangement of the image of reference information is changed in accordance with the opened/closed state.

The change in arrangement may be assumed in each of the opened state and the closed state. Therefore, the user can easily see the image of reference information on the display screen 104 in accordance with the assumed manner in which the user holds the housings during imaging operation in the opened or closed state.

For instance, in the case of the opened state, an imaging action is assumed to be performed in a state that the longitudinal directions of the housings 101 and 102 are vertically oriented such that a direction from the short side on the coupling section of the second housing 102 toward the other short side thereof (the direction “A” in FIG. 1A) is oriented in an upward direction of the display screen. In the case of the closed state, imaging operation is performed in a state that the longitudinal directions of the housings 101 and 102 are horizontally oriented such that a direction opposite the direction E (a direction B shown in FIG. 2A) is oriented in an upward direction of the display screen.

On condition that the manner of holding the housings is assumed as mentioned above, the control section 159 appropriately sets the position and orientation of the image of reference information such that the direction A is oriented in the upward direction of the display screen 104 in the case of the opened state and such that the direction B is oriented in the upward direction of the display screen 104 in the case of the closed state.

At the time of changing of the arrangement of the image of reference information, the control section 159 refers to the data table stored in the storage section 152. In the data table, the result of determination (the opened or closed state) made by the state determination section 153 is associated with the arrangement information about the image of reference information (e.g., coordinates on the display screen 104, a rotational angle, or the like). The control section 159 acquires the arrangement information corresponding to the result of determination made by the state determination section 153 from the data table and changes the arrangement of the image of reference information in accordance with the acquired arrangement information.

Operation of the portable cellular phone 10 having the foregoing configuration will be described hereafter in relation to chiefly the imaging function relevant to the invention.

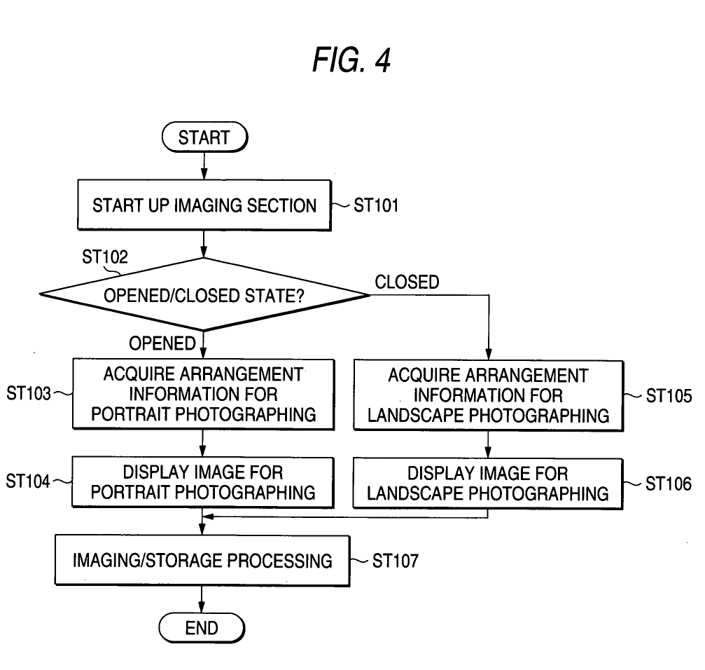

FIG. 4 is a flowchart illustrating an example flow of processing of a camera mode.

First, the control section 159 activates the imaging operation of the imaging section 157, to thus input data pertaining to images sequentially picked up by the imaging section 157 (step ST101).

On the basis of the result of determination made by the state determination section 153, the control section 159 determines whether the two housings 101 and 102 are in the opened or closed state (step ST102).

When the control section 159 determines that the two housings are in the opened state, the control section 159 acquires, from the data table of the storage section 152, arrangement information for portrait imaging and an association with the keys (step ST103). Images corresponding to the data picked up by the imaging section 157 are displayed on the display section 155, and images of each reference information, for which an arrangement is set on the basis of the arrangement information for portrait-orientation photographing (hereinafter called “portrait photographing”), are displayed on the display section 155 (step ST104).

When the control section 159 determines that the two housings are in the closed state, the control section 159 acquires, from the data table of the storage section 152, arrangement information for landscape-orientation photographing (hereinafter called “landscape photographing”) and an association with the keys (step ST105). Images corresponding to the data picked up by the imaging section 157 are displayed on the display section 155, and images of each reference information, for which an arrangement is set on the basis of the arrangement information for landscape photographing, are displayed on the display section 155 (step ST106).

When imaging execution information is input by way of the key input section 154 (an association between the keys is changed on the basis of whether the state of the phone is in the closed state or the opened state) while an image for photographing is displayed on the display section 155, the control section 159 subjects the data of an image picked up by the imaging section 157 to image processing, such as compression and encoding operations or the like, and stores the processed image data in the storage section 152 (step ST107).

The image display examples employed in steps ST104 and ST106 are described by reference to FIGS. 5A to 7.

FIGS. 5A and 5B are views illustrating, as an example of an image displayed during photographing operation, a display image appearing when the display includes an image showing an association between control information and the operation keys. FIG. 5A shows an example display image in the opened state, and FIG. 5B shows a display image in the closed state.

An image P1 is an image picked up by the imaging section 157.

An image P2 shows the receiving intensity of a signal transmitted by the base station.

An image P3 shows an image showing the remaining power of a battery.

Images P4 to P6 shown in FIG. 5A are images showing an association between the control information and the operation keys. Images P4A to P6A shown in FIG. 5B are images showing an association between the control information and the operation keys.

Namely, the image P4 shows that zoom rate setting information is associated with the operation key 111.

The image P5 shows that the imaging execution information is associated with the operation key 116.

The image P6 shows that the mode transition information is associated with the operation key 112.

The image P4A shows that the zoom rate setting information is associated with the operation key 124.

The image P5A shows that the imaging execution information is associated with the operation key 123.

The image P6A shows that the mode transition information is associated with the operation key 122.

As shown in FIGS. 5A and 5B, in either the portrait photographing operation (opened state) or the landscape photographing (closed state), the images of each reference information are arranged in a correct direction with respect to the upward direction (A or B) of the display screen 104.

In the case of the opened state (FIG. 5A), the image P2 showing receiving intensity is located at an upper left corner of the display screen 104, and the image P3 showing the remaining power of a battery is located at an upper right corner of the display screen 104. In relation to the images showing an association between the control information and the operation keys, the image P4 showing a zoom rate setting key is located at a lower left corner of the display screen 104; the image P6 showing a mode transition key to be used for shifting the current mode to a menu selection mode is located at a lower right corner of the display screen; and the image P5 showing an imaging execution key is located between the images P4 and P6. Therefore, as shown in FIG. 5A, the sequence in which the images P4, P5, and P6 are arranged on the display screen 104 is equal to the sequence in which operation keys 111, 116, and 112 are arranged on the first housing 101. The positions of the images P4, P5, and P6 on the display screen 104 become close to the positions of the operation keys 111, 116, and 112 on the first housing 101. Therefore, the user can intuitively grasp an association between the images P4, P5, and P6 and the operation keys 111, 116, and 112.

In the case of the closed state (FIG. 5B), the image P2 showing receiving intensity is located at the upper left corner of the display screen 104, and the image P3 showing the remaining power of the battery is located to the right of the image P2. In relation to the images showing an association between the control information and the operation keys, the image P4A showing the zoom rate setting key is located to the right of the image P3; the image P6A showing the mode transition key to be used for shifting the current mode to a menu selection mode is located at the upper right corner of the display screen; and the image P5A showing the imaging execution key is located between the images P4A and P6A. Therefore, even in the case of the closed state, the sequence in which the images P4A, P5A, and P6A are arranged on the display screen 104 is equal to the sequence in which operation keys 121, 123, and 122 are arranged on the first housing 101. The positions of the images P4A, P5A, and P6A on the display screen 104 become close to the positions of the operation keys 124, 123, and 122 on the first housing 101. Therefore, the user can intuitively grasp an association between the images P4A, P5A, and P6A and the operation keys 124, 123, and 122.

As the mentioned previously, the user can intuitively ascertain the operation keys by means of glancing at the position and orientation of the image of control information appearing on the display screen 104.

The operation keys and the control information are associated with each other in such a way that the user can readily operate the keys while orienting the phone vertically in the opened state and can easily operate the keys while orienting the phone horizontally in the closed state. In spite of this fact, the display arrangement for portrait photographing and the display arrangement for landscape photographing are made analogous to each other. Therefore, even when the photographing orientation is changed, the impression of a display screen remains unchanged, and an unusual feeling experienced by the user is diminished.

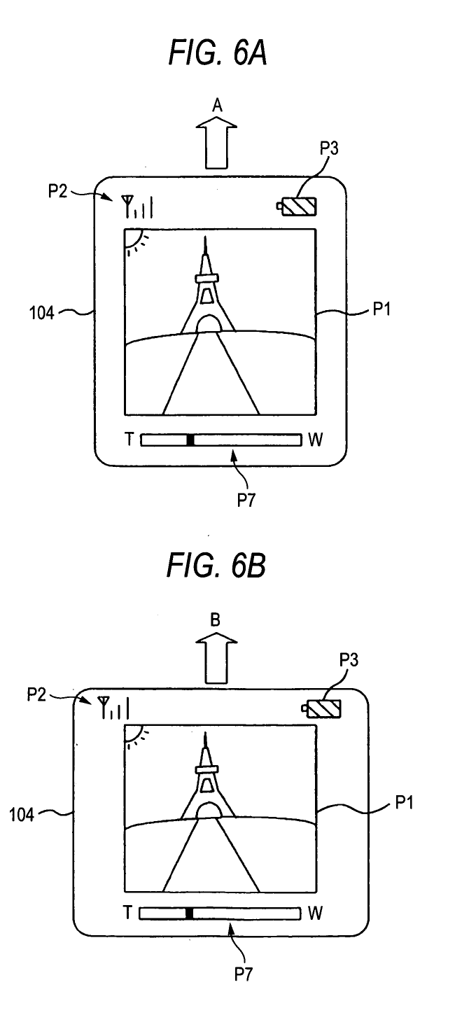

FIGS. 6A and 6B are views illustrating a display image appearing when the display includes an image showing a zoom rate of a picked-up image, as another example of an image displayed during photographing operation. FIG. 6A shows an example display image in the opened state, and FIG. 6B shows a display image in the closed state. Reference numerals common to FIGS. 5A, 5B, 6A and 6B designate the same images.

The embodiment shown in FIGS. 6A and 6B shows an image P7 representing a zoom rate of a picked-up image instead of the images P4 to P6 and P4A to P6A in the embodiment shown in FIGS. 5A and 5B.

The image P7 is in a rod-shaped external shape extending horizontally on the screen. A rectangular mark approximating a square which moves horizontally in accordance with a zoom rate is provided in the rod, namely the image P7.

As shown in FIGS. 6A and 6B, in the opened state and the closed state, the image P7 is arranged at the same position in the same orientation with respect to the upward direction (A or B) of the display screen 104. Specifically, the rod is horizontally laid below the picked-up image P1.

Therefore, even in this case, the display arrangement for portrait photographing and the display arrangement for landscape photographing are analogous to each other. Therefore, the unusual feeling experienced by the user is diminished.

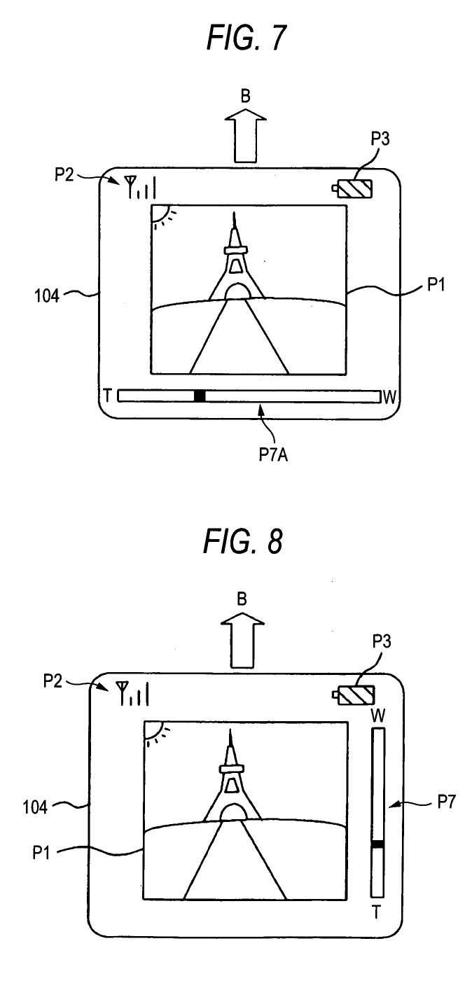

The control section 159 may change the longitudinal length of the image showing a zoom rate in accordance with a result of determination made by the state determination section 153. As shown in FIG. 7, an image P7A whose longitudinal length is made longer than that of the image P7 acquired through portrait photographing operation may be displayed, in a landscape photographing operation where the screen is extended horizontally. As a result, the zoom rate can be readily controlled in an elaborate manner, and elaborate differentiation of the zoom rate becomes possible.

Alternatively, the control section 159 may constantly maintain the arrangement of the image showing a zoom rate on the display screen 104, regardless of the result of determination made by the state determination section 153. As shown in, e.g., FIG. 8, the single arrangement of the image P7 is used in the landscape and portrait photographing operations, and the arrangement of an image of another reference information may be changed in accordance with the result of determination made by the state determination section 153. As a result, an empty space arises in the area where the image P7 is displayed in landscape orientation. Thus, for example, the images P4A to P6A are displayed in the empty space, thereby enabling effective utilization of the display screen 104.

As described above, according to the embodiment, the arrangement of the image of reference information to be displayed on the display screen 104 of the display section 155 along with a picked-up image is changed in accordance with the result of determination made by the state determination section 153.

Therefore, even when the manner of holding the housing which facilitates photographing action changes from the opened state to the closed state and even when the orientation of the display screen 104 with respect to the user changes depending on the manner of holding the housing, the arrangement of the image of reference information can be appropriately changed in accordance with the orientation of the display screen in respective manners of holding the housing, thereby enhancing visibility of the reference information.

The data table associating the result of determination made by the state determination section 153 with the arrangement information about the image of reference information is previously stored in the storage section 152. The control section 159 acquires, from the data table, the arrangement information corresponding to the result of determination made by the state determination section 153, and the arrangement of the image of reference information is changed in accordance with the acquired arrangement information.

Therefore, image data regarding the reference information do not need to be individually prepared for the opened and closed states. Therefore, the area required for storing the image data becomes small, thereby conserving the memory.

The invention is not limited to the above embodiment and susceptible to various modifications.

For instance, FIGS. 6A through 8 illustrate the images P7, P7A showing the zoom rate of a picked-up image as example images of reference information. However, a similar rod-shaped image may be displayed as an image showing the elapsed time for picking up video.

In FIGS. 6A and 6B, a state that the rectangular mark is situated at the left end of the rod corresponds to an elapsed time of zero. When imaging is initiated, the mark is moved from left to right. A distance over which the mark moves from the left end of the rod is proportional to the elapsed time for picking up video. An image analogous to the image P7 may be displayed on the display section 155 as an image showing an elapsed time for picking up video, by means of the processing of the control section 159.

In this case, the time which elapses while the mark moves from the left end of the rod to the right end of the same may be taken as a time for picking up video corresponding to the maximum quantity of data which can be transmitted by the portable cellular phone 10 in a single operation.

The control section 159 may change the size or aspect ratio of the picked-up image to be displayed on the display screen 104, in accordance with the result of determination made by the state determination section 153. As a result, the arrangement of the image on the display screen 104 may be freely changed in accordance with the manner of operation.

The control section 159 may convert the arrangement of data pertaining to respective pixels in the picked-up image data in accordance with the result of determination made by the state determination section 153 such that a reproduced image of the picked-up image data is rotated through a predetermined angle.

On condition that a single subject is photographed in the portrait orientation (opened state) and the landscape orientation (closed state) and that the data pertaining to the picked-up images are reproduced in their present forms, a subject in one image is displayed while being oriented at an angle of 90° with respect to a subject in another image.

Therefore, data arrangement of each pixel in the picked-up image data is converted with reference to data of an image picked up in portrait orientation such that an image reproduced from the data of an image picked up in landscape orientation is rotated through 90°. Thus, the orientation of the reproduced images picked up in portrait and landscape orientation can be aligned with each other.

In the above embodiment, the operation keys 122 to 124 are provided on the side surface of the first housing 101. However, in spite of the embodiment, the keys may be arranged on the side surface of, e.g., the second housing 102, or on the surface of the second housing 102.

The above embodiment show an example in which key-type input section is used as information input section. However, the invention may be applied to a portable cellular phone which inputs data by means of detecting rotation of, e.g., a wheel or ball, or other various data input section such as non-contact data input section utilizing static electricity or light.

The above embodiment shows an example in which processing of the control section 159 is performed by a computer in accordance with a program. At least portions of the processing operations may be carried out by means of hardware.

Conversely, at least portions of the processing in another unit other than the control section 159 may be performed by the computer of the control section 159.

1. An imaging apparatus comprising:
a first housing;
a second housing which has a display section for displaying a picked-up image and is coupled to the first housing through a coupling section;
a state determination section that determines an opened/closed state of the second housing with respect to the first housing; and
a control section that changes an arrangement of images regarding reference information to be displayed on a display screen of the display section along with the picked-up image, in accordance with a determination result made by the state determination section.

2. The imaging apparatus according to claim 1, further comprising:
a storage section that stores arrangement information of the image regarding the reference information in association with the determination result of the state determination section,
wherein the control section acquires the arrangement information corresponding to the determination result of the state determination section from the storage section, and changes the arrangement of the images regarding the reference information in accordance with the acquired arrangement information.

3. The imaging apparatus according to claim 1, further comprising:
a plurality of information input sections that are arranged on one or both of the first housing and the second housing, and is used to input a control information for controlling processes regarding an imaging function of the imaging apparatus,
wherein the control section sets association between the control information and the information input section to be used for inputting the control information, in accordance with the determination result of the state determination section, and changes position and orientation on the display screen of images representing at least part of the information input sections to which the association is set, in accordance with the determination result of the state determination section.

4. The imaging apparatus according to claim 1,
wherein the reference information includes at least one of a zoom rate of picking up an image and an elapsed time of picking up video, and
the control section changes position and orientation on the display screen of the images regarding the reference information in accordance with the determination result of the state determination section.

5. The imaging apparatus according to claim 4,
wherein the images regarding the reference information are formed in an essentially rectangular shape, and
the control section changes a longitudinal length of the images in accordance with the determination result of the state determination section.

6. The imaging apparatus according to claim 1,
wherein the reference information includes at least one of a zoom rate of the picking up an image and an elapsed time of picking up video, and
the control section fixes position and orientation on the display screen of part of the images regarding the reference information regardless of the determination result of the state determination section, and changes the arrangement of other images regarding the reference information than the part of the images in accordance with the determination result of the state determination section.

7. The imaging apparatus according to claim 1,
wherein the control section changes a size or an aspect ratio of the picked-up image to be displayed on the display screen in accordance with the determination result of the state determination section.

8. An imaging apparatus having two housings and a coupling section that rotatably couples the two housings, comprising:
an imaging section;
a display section that is disposed on one of the two housings and displays an image picked up by the imaging section;
a state determination section that determines whether the two housings are in a first state where one housing having the display section covers a predetermined area of another housing, or in a second state where the predetermined area of the another housing is exposed; and
a control section that changes an arrangement of images regarding reference information to be displayed on a display screen of the display section along with the picked-up image, in accordance with a result of a determination result made by the state determination section.
